(19) United States
(12) Patent Application Publication
(10) Pub. No.: US 2025/0355104 A1
(43) Pub. Date: Nov. 20, 2025

(54) RECONFIGURABLE INTELLIGENT SURFACES DETECTION USING FREQUENCY MODULATED CONTINUOUS WAVE RADAR DEVICES

(71) Applicant: NEC Laboratories Europe GmbH, Heidelberg (DE)

(72) Inventors: Lanfranco Zanzi, Heidelberg (DE); Francesco Devoti, Heidelberg (DE); Guillermo Encinas Lago, Heidelberg (DE)

(21) Appl. No.: 19/201,980

(22) Filed: May 8, 2025

(30) Foreign Application Priority Data
May 14, 2024 (EP) 24175715

(51) Int. Cl. G01S 13/34; G01S 13/931; H04B 7/04

(52) U.S. Cl. CPC G01S 13/34; G01S 13/931; H04B 7/04013

(57) ABSTRACT

A computer-implemented method for detecting the presence of a reconfigurable intelligence surfaces (RIS) device using a radar device includes receiving an analog received (RX) signal using a receiver antenna of the radar device based on a transmitted (TX) signal. The method further includes mixing the TX signal and the analog RX signal to generate an intermediate frequency (IF) signal and processing the IF signal to detect a characteristic of the IF signal that indicates a presence of the RIS device. The method has applications in optimization and/or decision making associated with robots. For instance, based on performing the RIS detection, the robot can optimize its path to survey an environment (e.g., maximize exploration rate that is constrained by the battery of the robot). In some embodiments, machine learning (ML) and/or artificial intelligence (AI) techniques can be used to perform the RIS detection.

### CROSS REFERENCE TO RELATED APPLICATIONS

This application claims benefit to European Patent Application No. EP 24175715.2, filed on May 14, 2024, which is hereby incorporated by reference herein.

### FIELD

The present disclosure relates to detection of reconfigurable intelligent surface (RIS) devices within an environment, and in particular to a method, system, data structure, computer program product and computer-readable medium for detecting the presence of RIS devices using frequency modulated continuous wave (FMCW) radar devices.

### BACKGROUND

The frequency-selective behavior that is inherent in RIS devices can have adverse implications on the functionality of radar devices. For example, this behavior can introduce challenges in radar operations that can potentially lead to distortions in the signal received by the radar devices, which can impact their ability to precisely detect and track targets. As such, understanding and mitigating the negative impacts of RIS devices on radar operations is crucial for enhancing the overall performance and reliability of radar technologies in a variety of diverse applications such as from robotic scenarios to automotive scenarios.

In some embodiments, the presence of RISs can cause the radar to provide false readings, which can pose a problem in many different situations and circumstances. One such embodiment where this can be an issue is when ground robots are performing exploration tasks in indoor scenarios. For instance, as part of the mapping or localization process, the robot can navigate the environment and build knowledge about surrounding objects. Further, the robot can, for example, optimize its path to maximize the exploration rate constrained by its limited battery availability. This objective can generally be achieved by mounting a radar device on the robot and locally processing their signals to build such a map. However, due to the presence of RISs, the radar can provide distorted and/or false readings, which can lead to difficulty in the robot achieving its objective (e.g., accurately building a map of its surroundings and/or optimizing the path to maximize the exploration rate).

### SUMMARY

In an embodiment, the present disclosure provides a computer-implemented method for detecting the presence of a reconfigurable intelligence surfaces (RIS) device using a radar device. The method includes, based on transmitting a transmitted (TX) signal using a transmitter antenna of the radar device, receiving an analog received (RX) signal using a receiver antenna of the radar device. The method further includes mixing the TX signal and the analog RX signal using a mixer of the radar device to generate an intermediate frequency (IF) signal. The method also includes processing the IF signal using an RIS detector to detect a characteristic of the IF signal that indicates a presence of the RIS device and outputting an RIS detected signal based on the characteristic indicating the presence of the RIS device. In some instances, embodiments of the present disclosure have applications in optimization and/or decision making associated with robots. For instance, based on performing the RIS detection, embodiments of the present disclosure can allow a robot to optimize its path to survey an environment (e.g., maximize exploration rate that is constrained by the battery of the robot). Additionally, and/or alternatively, in some embodiments, machine learning (ML) and/or artificial intelligence (AI) techniques can be used to perform the RIS detection.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates an example environment that includes a robot equipped with a radar;

FIG. 2 illustrates another example environment that includes the robot equipped with the radar, but the environment also includes a deployed RIS;

FIG. 3 illustrates graphical representations of a Chirp signal in the time and time-frequency domain according to one or more embodiment of the present disclosure;

FIG. 4 illustrates example signal representations, including intermediate frequency (IF) signal representations, according to one or more embodiments of the present disclosure;

FIG. 5 illustrates an overview of a modification to a radar device to detect RIS devices according to one or more embodiments of the present disclosure;

FIG. 6 illustrates resulting signal representations in the presence of an RIS according to one or more embodiments of the present disclosure;

FIG. 7 illustrates another overview of a modification to the radar device to detect RIS devices based on a readings classification according to one or more embodiments of the present disclosure;

FIG. 8 illustrates another set of resulting signal representations in the presence of an RIS according to one or more embodiments of the present disclosure;

FIG. 9 illustrates frequency dependent signal detection in the intermediate frequency according to one or more embodiments of the present disclosure;

FIG. 10 illustrates yet another overview of a modification to the radar device to detect RIS devices based on signal detection according to one or more embodiments of the present disclosure;

FIG. 11 illustrates yet another overview of a modification to the radar device to detect RIS devices based on speed readings according to one or more embodiments of the present disclosure;

FIG. 12 illustrates yet another overview of a modification to the radar device to detect RIS devices based on a data-driven architecture according to one or more embodiments of the present disclosure; and

FIG. 13 is a block diagram of an exemplary processing system, which can be configured to perform any and all operations disclosed herein.

### DETAILED DESCRIPTION

As mentioned above, the frequency-selective behavior that is inherent in RIS devices can provide adverse implications on the functionality of radar devices. This can cause the radar devices to fail their objectives in multiple different scenarios such as when ground robots use the radar devices for performing exploration tasks. For instance, radars are active devices that work by sequentially transmitting and receiving radio frequency (RF) signals. By measuring variations in the RF characteristics (e.g., amplitude, frequency, phase, and other characteristics) of a reflected signal hitting an obstacle, an ad-hoc algorithm can estimate the obstacle location and its distance from the signal emitter. This can prove useful in mapping the surroundings of the robotic device, and can further lead to maximizing the exploration rate, which can be constrained by the robot's limited battery life. As an alternative, instead of measuring variations in the RF characteristics, the radars can simply transmit impulses and measure the time-of-flight (TOF) of the reflected signal, which can also prove useful in such scenarios. However, due to the frequency-selective behavior of RIS devices, the radar signals (e.g., the variations in the RF characteristics and/or the TOF measurements) that are received by the radar devices can become distorted, which can cause false and/or inaccurate readings. These false and/or inaccurate readings can impact the overall objective of the robot such as inaccurately mapping the location of surrounding objects. In other situations, false and/or inaccurate readings from radar devices that are caused by RIS devices can become even more problematic, such as when the distance readings are utilized as a fundamental part of a safety mechanism. For example, in scenarios with autonomous cars, fast moving equipment, and/or other scenarios that utilize safety mechanisms, the false readings from radar devices can lead to numerous and problematic issues.

As such, embodiments of the present disclosure describe methods and/or systems that effectively and/or efficiently detect and/or mitigate the presence of RIS devices that are deployed in an area and/or environment. For example, embodiments of the present disclosure can describe radar devices (e.g., Frequency Modulated Continuous Wave (FMCW) radar devices) that include an RIS detector module, which can be configured to detect RIS devices within an environment. The RIS detector module (e.g., an RIS detector processor and/or components) can include a plurality of components (e.g., a signal-based detector, a speed-based RIS detector, and/or a software-based component, which can be optional) and/or perform a plurality of functionalities. By using the RIS detector module, numerous advantages can be achieved including, but not limited to, the capability of detecting RIS devices that are deployed within an area, which can be useful to avoid both communication and/or sensing errors due to the reflection properties of RIS devices in the presence of uncoordinated and/or unaware electromagnetic wave propagation. This will be described in further detail below.

According to a first aspect, the present disclosure provides a computer-implemented machine learning method for detecting the presence of a reconfigurable intelligence surfaces (RIS) device using a radar device. The method comprises, based on transmitting a transmitted (TX) signal using a transmitter antenna of the radar device, receiving an analog received (RX) signal using a receiver antenna of the radar device; mixing the TX signal and the analog RX signal using a mixer of the radar device to generate an intermediate frequency (IF) signal; processing the IF signal using an RIS detector to detect a characteristic of the IF signal that indicates a presence of the RIS device; and outputting an RIS detected signal based on the characteristic indicating the presence of the RIS device.

According to a second aspect, the method according to the first aspect further comprise that the radar device is a frequency modulated continuous waveform (FMCW) radar device, the TX signal and the analog received RX signal are FMCW radar signals, and processing the IF signal using the RIS detector comprises: providing the RIS detector with the IF signal after performing demodulation, filtration, and amplification; and detecting the characteristic based on the provided IF signal.

According to a third aspect, the method according to any of the first or the second aspect further comprises that detecting the characteristic of the IF signal comprises: detecting the characteristic of the IF signal within a confined operating frequency bandwidth associated with the RIS device, wherein the characteristic is a signal variation indicating a sudden signal loss within the confined operating frequency bandwidth or alterations of an amplitude of the IF signal within the confined operating frequency bandwidth.

According to a fourth aspect, the method according to any of the first to third aspects further comprises detecting the characteristic of the IF signal comprises: processing the IF signal using a chirp frequency moving average to obtain an average amplitude; determining a difference between an amplitude of the IF signal and the average amplitude; comparing the difference with a threshold to determine the characteristic of the IF signal; and generating the RIS detected signal based on the characteristic.

According to a fifth aspect, the method according to any of the first to fourth aspects further comprises that the characteristic indicates whether the IF signal comprises a rectangular pulse for a time interval associated with a confined operating frequency bandwidth of the RIS device, wherein generating the RIS detect signal is based on the IF signal comprising the rectangular pulse, and wherein the computer-implemented method further comprises: generating an RIS not detected signal based on the IF signal not including the rectangular pulse.

According to a sixth aspect, the method according to any of the first to fifth aspects further comprises monitoring one or more additional characteristics of one or more additional IF signals associated with subsequent modulation cycles to confirm that the characteristic and the one or more additional characteristics are within a same frequency window, and wherein generating the generated RIS detected signal is based on the confirmation.

According to a seventh aspect, the method according to any of the first to sixth aspects further comprises that monitoring the one or more additional characteristics of the one or more additional IF signals comprises: obtaining the one or more additional IF signals based on mixing additional TX signals and additional RX signals in the subsequent modulation cycles; and determining that the one or more additional characteristics of the one or more second IF signal comprise one or more rectangular pulses that are at the same frequency window as a rectangular pulse associated with the characteristic.

According to an eighth aspect, the method according to any of the first to seventh aspects further comprises that detecting the characteristic of the IF signal comprises: comparing, using an amplitude comparator, the IF signal with a background noise threshold to obtain a first amplitude output; comparing, using a signal delay and a cycle comparator, the first amplitude output with previous amplitude outputs from the amplitude comparator to obtain the characteristic, wherein the characteristic indicates a sudden signal loss at a confined operating frequency bandwidth associated with the RIS device; and generating the RIS detected signal based on the characteristic.

According to a ninth aspect, the method according to any of the first through eighth aspects further comprises that detecting the characteristic of the IF signal comprises: performing a doppler shift on the analog RX signal to obtain a doppler shifted signal; computing a time derivative of the IF signal to obtain a speed signal, wherein the speed signal infers speed values out of a temporal variation of distance readings associated with the IF signal; and generating the RIS detected signal based on a comparison of the speed signal and the doppler shifted signal.

According to a tenth aspect, the method according to any of the first through ninth aspects further comprises that generating the RIS detected signal based on the comparison of the speed signal and the doppler shifted signal comprises: determining a difference between the speed signal and the doppler shifted signal; and comparing the difference with a threshold to generate a speed comparator output, wherein generating the RIS detected signal is based on the speed comparator output.

According to an eleventh aspect, the method according to any of the first through tenth aspects further comprises that generating the RIS detected signal comprises: comparing the speed comparator output with a previous speed comparator output that is associated with a previous modulation cycle; and generating the RIS detected signal based on the comparison between the speed comparator output and the previous speed comparator output.

According to a twelfth aspect, the method according to any of the first through eleventh aspects further comprises that the RIS detector is a machine learning (ML) RIS detector, and wherein processing the IF signal comprises: processing the IF signal and additional information using an ML based architecture to detect the characteristic indicating the presence of the RIS device, wherein the additional information comprises a doppler speed signal, a chirp modulation, position information associated with the transmitter antenna and the receiver antenna, and/or orientation information associated with the transmitter antenna and the receiver antenna.

According to a thirteenth aspect, the method according to any of the first through twelfth aspects further comprises that the ML based architecture comprises a neural network or a reinforcement agent, and wherein the method further comprises: obtaining training data comprising first input information associated with one or more first environments having one or more training RIS devices within the one or more first environments and second input information associated with one or more second environments without having the one or more training RIS devices within the one or more second environments; and training the neural network based on training data.

According to an fourteenth aspect, a computer system is provided for detecting the presence of a reconfigurable intelligence surfaces (RIS) device using a radar device. The computer system comprises one or more hardware processors, which, alone or in combination, are configured to provide for execution of the following steps: based on transmitting a transmitted (TX) signal using a transmitter antenna of the radar device, receiving an analog received (RX) signal using a receiver antenna of the radar device; mixing the TX signal and the analog RX signal using a mixer of the radar device to generate an intermediate frequency (IF) signal; processing the IF signal using an RIS detector to detect a characteristic of the IF signal that indicates a presence of the RIS device; and outputting an RIS detected signal based on the characteristic indicating the presence of the RIS device.

A fifteenth aspect of the present disclosure provides a tangible, non-transitory computer-readable medium having instructions thereon, which, upon being executed by one or more processors, provides for execution of the method according to any of the first to the twelfth aspects and/or the method comprising the following: based on transmitting a transmitted (TX) signal using a transmitter antenna of the radar device, receiving an analog received (RX) signal using a receiver antenna of the radar device; mixing the TX signal and the analog RX signal using a mixer of the radar device to generate an intermediate frequency (IF) signal; processing the IF signal using an RIS detector to detect a characteristic of the IF signal that indicates a presence of the RIS device; and outputting an RIS detected signal based on the characteristic indicating the presence of the RIS device.

Prior to describing embodiments of the present disclosure (e.g., the RIS detector module), RIS devices and radar devices (e.g., FMCW radar devices) are first described. For example, RIS devices can include arrays of passive patch antennas. The configuration of the RIS devices can be dynamically controlled to change their reflective properties and steer and/or focus the signal on the desired direction. For instance, RIS devices can have the ability of changing how the wave propagates within the environment, and they can be typically used for communication purposes by providing high gain reflected paths to cover shadowed areas and/or enhance communication performances. RIS devices can be deployed in both indoor and/or outdoor environments. Such devices are typically narrowband, as they can manipulate the signal propagation in a typically predefined range of frequencies (e.g., within a bandwidth of influence (BoI)) (see, e.g., RIS-enabled smart wireless environments: deployment scenarios, network architecture, bandwidth and area of influence, George C. Alexandropoulos et al, EURASIP Journal on Wireless Communications and Networking, Volume 2023, article number 103, which is hereby incorporated by reference herein). RIS devices have been used in sensing applications such as localization and/or radar to improve detection performance and accuracy. However, when they are deployed and controlled only for communication purposes (e.g., without considering their effect on sensing entities such as radars operating in the area), they might lead to a lower accuracy (see, e.g., Y. He, Y. Cai, H. Mao and G. Yu, “RIS-Assisted Communication Radar Coexistence: Joint Beamforming Design and Analysis,” in IEEE Journal on Selected Areas in Communications, vol. 40, no. 7, pp. 2131-2145 July 2022, doi: [10.1109/JSAC.2022.3155507], which is hereby incorporated by reference herein).

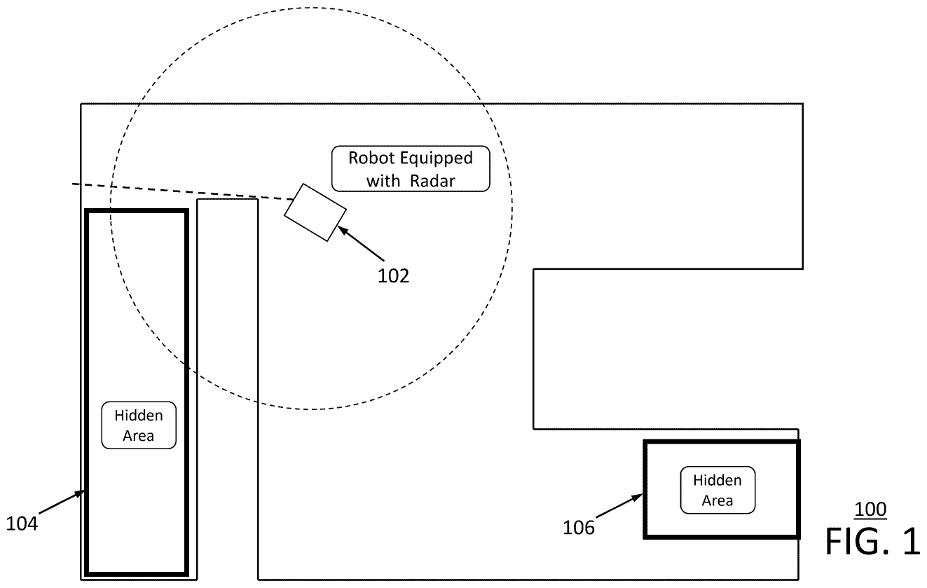

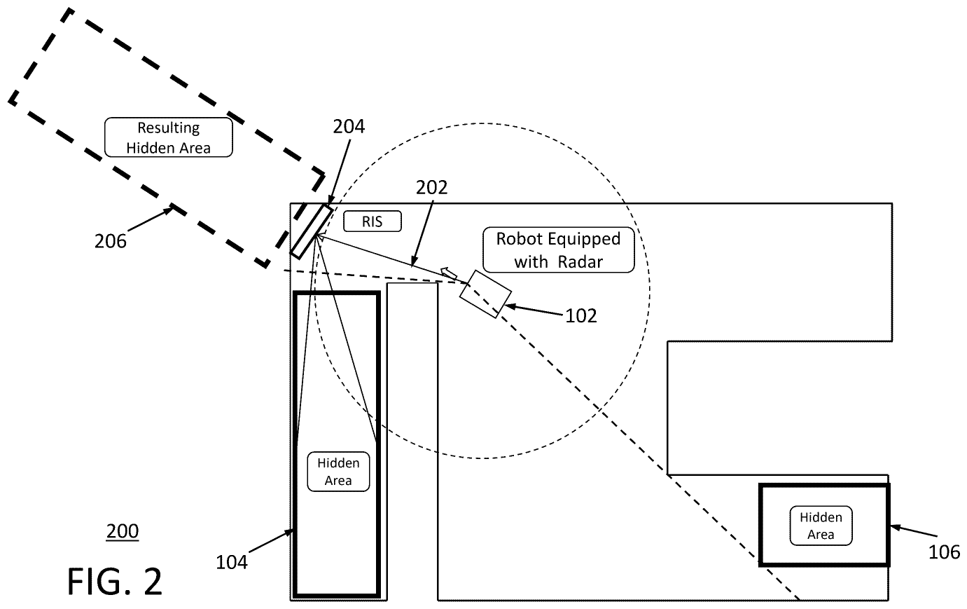

Turning to the scenarios described above, explorative robots that are equipped with radar devices can be operating within an area where one or more RIS devices can be deployed. The explorative robots can have their operations impacted by the presence of the RIS devices. In the following (e.g., FIGS. 1 and 2), the effect of RIS devices, which can become problematic for radar devices, is first described. Subsequently, the description of the operation of a common radar technology (e.g., the frequency modulated continuous waveform (FMCW) radar, which is the radar that one or more embodiments of the present disclosure developed solutions for) is next described. Following, the effect of RIS devices on the signals leveraged by FMCW radars to operate is described.

For example, FIG. 1 illustrates an example environment 100 that includes a robot 102 equipped with a radar. Specifically, the environment 100 includes the robot and radar 102 as well as two hidden areas 104 and 106. For example, the robot 102 can be equipped with radar and can move in an area. The radar can be used to map the environment 100. However, due to the presence of some walls, parts of the environment 100 can be hidden from the radar such as the hidden areas 104 and 106. In the application of area mapping, the wall being detected by the robot 102 is a desired effect. For instance, as a result of this, the robot 102 is correctly aware of the presence of walls and can adjust its exploration and navigation path accordingly to reach the unexplored areas (e.g., the hidden areas 104 and 106). For example, the robot 102 can move around the environment 100 and use its radar to change the detection range and/or detection signals (e.g., denoted by the dotted circle). In some instances, the dotted circle around the robot 102 can represent an example of the radar range/detection area. In FIG. 1, it is shown to be fixed, but in some variations, the radar range/detection area can vary depending on the chirp signal characteristics (e.g., the bandwidth and/or duration). The dotted line can represent the boundary between the area in the direct line of sight (e.g., not obstructed by obstacles or walls) and the obstructed area (e.g., the hidden area 104).

In contrast, FIG. 2 illustrates another example environment 200 that includes the robot 102 equipped with the radar, but the environment 200 also includes a deployed RIS 204. For example, assuming that the RIS 204 (e.g., an RIS device) is operating on a frequency band that is overlapping with the operational bandwidth of the radar of the robot 102 and the robot 102 is not aware of the presence of the RIS 204, the RIS 204 can steer the signal 202 used for sensing the environment 200. For example, the robot 102 can provide the signal 202, which can be redirected by the RIS 204 towards the hidden area 104. If the robot 102 is aware of the RIS 204, this can be desirable as the robot 102 can detect the hidden area 104. However, if the robot 102 is unaware of the RIS 204, this can lead to erroneous object reconstruction from the radar perspective of the robot 102. For instance, the robot 102 can interpret the redirection of the signal 202 as indicating that there is a resulting hidden area 206 that is behind the RIS 204. Unfortunately, this might not be the case and the robot 102 can instead crash into a wall based on the erroneous object reconstruction. In other words, based on the RIS steering the original signal 202, this can be leveraged to reach hidden areas (e.g., the hidden area 104); however, in the most common case where the robot is unaware of the presence of the RIS 204, this can result in errors when mapping the area, which can potentially result in a failure in the whole process.

Below, the background on radars, including FMCW radars are described. For example, a radar operates by iteratively transmitting and receiving reflected signals hitting surrounding objects. For instance, electromagnetic signals are transmitted (TX) by an antenna, the signal hits objects, and a portion of it is reflected towards the emitting source. The signal reaching the radar is then received (RX) by a receiving antenna.

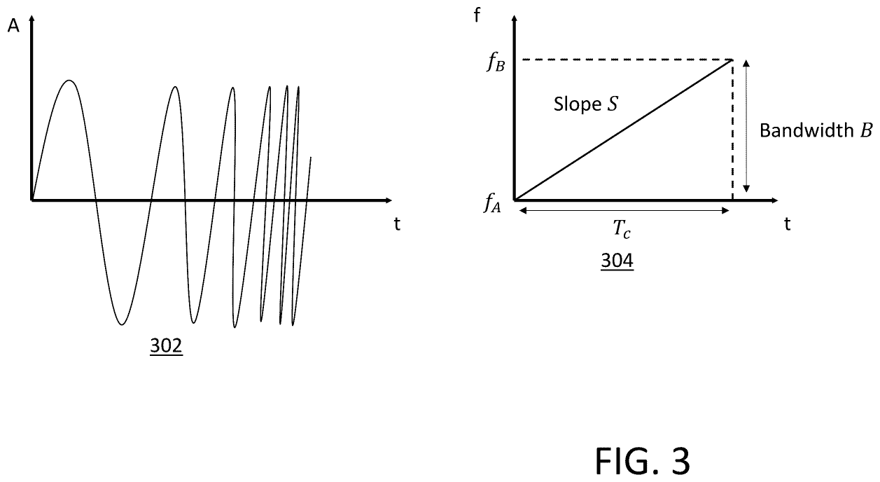

FMCW radars are a widely used type of radar that adopt continuous waveforms and frequency modulation techniques. For example, an FMCW radar operates by transmitting a radio signal called Chirp. This kind of signal is characterized by a sinusoidal shape whose frequency increases linearly with time. A chirp can be mathematically described by a starting frequency f_{A}, an ending frequency f_{B}, a bandwidth B, and a time duration T_{c}. An example chirp signal is depicted in FIG. 3.

For instance, FIG. 3 illustrates graphical representations 302 and 304 of a Chirp signal in the time and time-frequency domain according to one or more embodiments of the present disclosure. For example, the graphical representation 302 can be the time domain t. Specifically, the graphical representation 302 shows the amplitudes A of the Chirp signal over a period of time. The graphical representation 304 shows the time-frequency domain of the same Chirp signals. For instance, over a time duration T_{c}, the frequency of the Chirp signal increases linearly from the starting frequency f_{A} to the ending frequency f_{B}. The slope S of the Chirp signal as well as the bandwidth B of the Chirp signal are also shown.

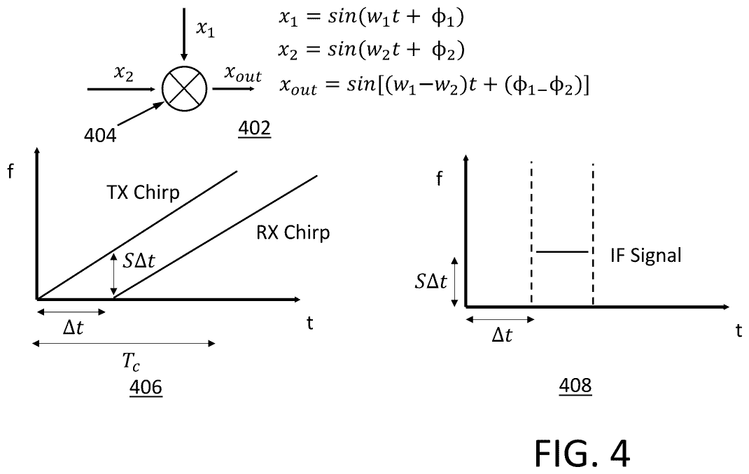

In the case of FMCW radars, the TX signal and the RX signal are mixed to form an intermediate frequency (IF) signal. In general, the resulting signal can have an instantaneous frequency equal to the difference of the two input signals, and a phase equal to the difference of the phase of the two input sinusoids. This is described in FIG. 4.

FIG. 4 illustrates example signal representations 402-406, including intermediate frequency (IF) representations, according to one or more embodiments of the present disclosure. For example, as mentioned above, in the representation 402, the TX signal (e.g., x₁) and the RX signal (e.g., x₂) can be mixed by a mixer 404 to generate an output, which can be the IF signal (e.g., xₒᵤₜ). This can further be represented by the mathematical expressions for the TX signal, the RX signal, and the IF signal, which are shown below:

$$\begin{matrix}{x}_{1} = sin ( {w}_{1} t + {ϕ}_{1} ) \\ {x}_{2} = sin ( {w}_{2} t + {ϕ}_{2} ) \\ {x}_{out} = sin [ ( {w}_{1} - {w}_{2} ) t + ( {ϕ}_{1} - {ϕ}_{2} ) ]\end{matrix}$$

For example, the TX signal, x₁, can be determined based on the sine function of the angular frequency w₁, the time t, and the phase ϕ₁. Similarly, the RX signal, x₂, can be determined based on the sine function of the angular frequency w₂, the time t, and the phase ϕ₂. Based on using the mixer 404, the IF signal xₒᵤₜ can have an instantaneous frequency equal to the distance of the two input signals (e.g., (w₁−w₂)t) and a phase equal to the difference of the phase of the two input sinusoids (e.g., (ϕ₁−ϕ₂)).

Thus, as shown in the graphical representation 406, which can be in the time-frequency domain, the RX signal (e.g., the RX chirp) can be represented as a delayed version of the TX signal (e.g., the TX chirp) where Δt is the round-trip time between the radar and the object. A single static target placed in front of the radar can result in an IF signal with a constant frequency

$$S Δ t = \frac{S 2 D}{c}$$

where S is the frequency slope, D is the distance to the object, and c is the propagation speed of the signal, which is equal to the speed of light. The graphical representation 408 shows this constant IF signal in the time-frequency domain.

Embodiments of the present disclosure will now be described. In addition, while one or more embodiments of the present disclosure will be described below in the context of modifications to the FMCW radar to detect the RIS devices, embodiments of the present disclosure can be included and/or used with other types of radar devices.

For instance, it appears evident that when adopting a radar device, the narrowband selectivity of an RIS device can represent a distinctive characteristic that can hardly be found in other materials when dealing with realistic scenarios. Such behavior represents a valuable input for designing and/or implementing an RIS detection system that can be embedded in the standard radar operations and reveal the presence of an RIS deployed in the area.

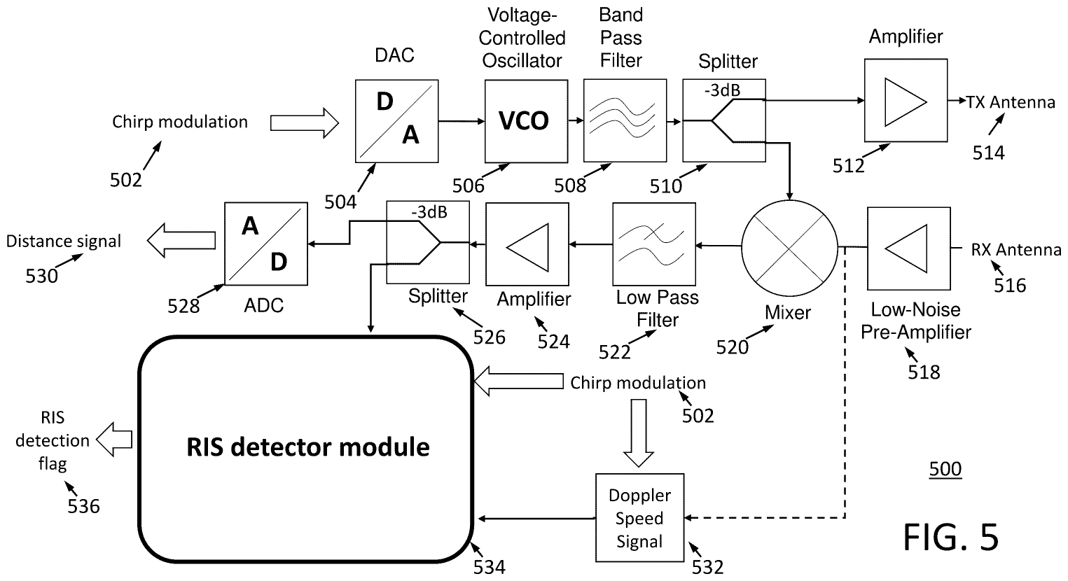

Therefore, as will be described in further detail below, embodiments of the present disclosure describe a method to automatically detect such behavior. For example, embodiments of the present disclosure can include an auxiliary module (e.g., device, component, and/or processor) that can be added to existing radar devices (e.g., FMCW radar devices) to provide additional processing logic to allow the radar to deal with RIS influence on the received electromagnetic signal. This is shown in FIG. 5.

FIG. 5 illustrates an overview 500 of a modification to a radar device (e.g., an FMCW radar) to detect RIS devices according to one or more embodiments of the present disclosure. For example, the overview 500 shows a chirp modulation 502 such as the chirp signal described in FIG. 3. The chirp modulation 502 is passed through a digital to analog converter (DAC) 504, through a voltage-controlled oscillator (VCO) 506, a band-pass filter 508, a splitter 510, and an amplifier 512. The output from the amplifier 512 is provided to the TX antenna 514, which outputs a TX signal such as the TX signal described in FIG. 4.

The RX Antenna 516 obtains the RX signal such as the RX signal described in FIG. 4 and passes the RX signal through a low-noise pre-amplifier 518 to the mixer 520. As described in FIG. 4, the mixer 520 can mix the RX signal obtained from the RX antenna and the TX signal. For instance, the splitter 510 (e.g., a −3 decibel (dB) splitter) can split the signal to provide it to both the amplifier 512 and the mixer 520. The mixer 520 can mix the RX signal and the TX signal to obtain the IF signal, which is described in FIG. 4. Subsequently, the IF signal can be processed by the low pass filter 522, the amplifier 524, another splitter 526, and an analog to digital converter (ADC) to generate a distance signal 530.

In addition to the above, an RIS detector module 534 can be used to detect the presence of RIS devices such as the RIS device 204 shown in FIG. 2. For example, the doppler speed signal block 532 can process the signal from the low-noise pre-amplifier 518 (e.g., the received RX signal from the RX antenna 516) and the chirp modulation 502 and provide the processed doppler speed signal to the RIS detector module 534. In addition, the RIS detector module 534 can further obtain the chirp modulation 502 and the processed IF signal from the splitter 526. Based on one or more of the inputs, the RIS detector module 534 can output an RIS detection flag 536. In the following, the RIS detector module 534 as well as its main functionalities and operations in different scenarios and operational conditions will be described.

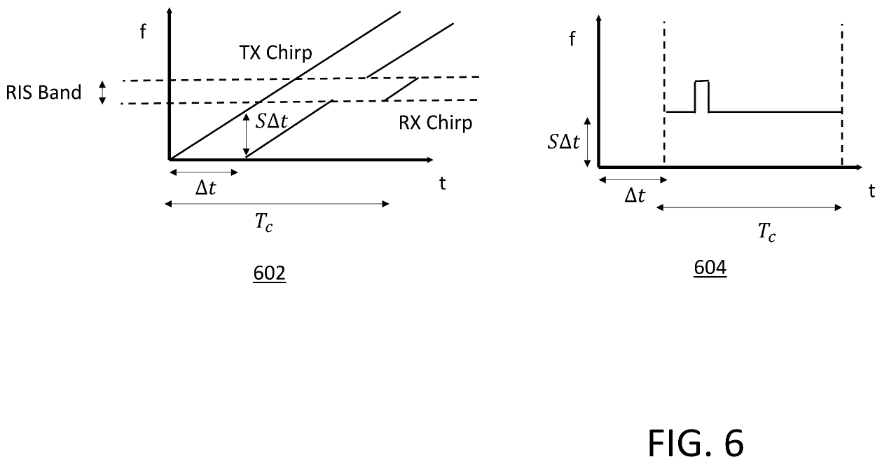

For example, in one or more first embodiments, a static object reflecting the impinging signal due to a deployment of an RIS device (e.g., the RIS device 204) is described. In these examples, embodiments of the present disclosure can consider a static RIS device (e.g., a stationary RIS device 204) that reflects the impinging signal (e.g., the TX signal from the TX antenna 514) in such a way that the signal can still reach the receiver (e.g., the RX antenna 516). For instance, the RIS can be reflecting the signal in the direction of an obstacle, which in turn reflects (e.g., passing again through the RIS) the signal back to the radar device. The signal representations for this scenario are shown in FIG. 6.

For example, FIG. 6 illustrates resulting signal representations 602-604 in the presence of an RIS according to one or more embodiments of the present disclosure. For instance, the signal representations 602 and 604 (e.g., graphical representations of the signals such as the TX and RX chirps as well as the IF signal) can be associated with a resulting IF signal that is in the presence of an RIS device with a delayed narrowband reflected signal and static target. For example, in contrast to the representation 406 of FIG. 4, the signal representation 602 shows the TX chirp and the RX chirp, but the RX chirp has a portion that is received subsequently within the time domain. For instance, instead of the RX chirp being a linear line, which is shown in representation 406, the RX chirp in representation 602 includes a section within the RIS band that is received at a later time, which causes a disconnect in the linear line. This is further shown in the signal representation 604 for the IF signal. For instance, in contrast to representation 408, which is a constant IF signal in the time-frequency domain, the IF signal shown in the signal representation 604 is not constant and includes a change in frequency (e.g., shown as a rectangular pulse).

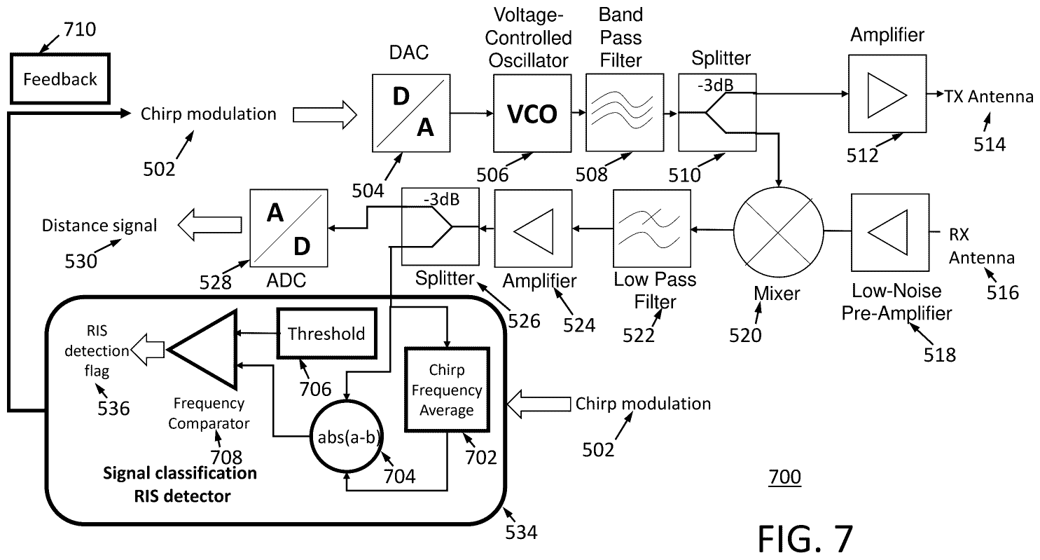

In other words, the signal representations 602 and 604 can show how the received chirp can be characterized. For instance, in the portion of the signal corresponding to the bandwidth of influence of the RIS device (e.g., the RIS band shown in the signal representation 602), a larger delay is shown for the RX chirp, which can be based on the larger path caused by the RIS reflection. From the physical point of view, only an obstacle that moves almost instantaneously to a different location (and returns back to the original position) would be capable of creating the same time-frequency pattern in the reflected chirp. In other words, the object would be capable of an almost infinite acceleration that is physically not possible. Nonetheless, this effect can be clearly leveraged to detect the presence of frequency selective devices in the area, such as RIS devices, as well as to estimate the bandwidth of influence of the RIS device. This is shown in FIG. 7.

For example, FIG. 7 illustrates another overview 700 of a modification to the radar device (e.g., the FMCW radar device) to detect RIS devices based on a readings classification according to one or more embodiments of the present disclosure. For instance, the overview 700 includes many of the similar components and/or entities from the overview 500 such as the chirp modulation 502, the DAC 504, the VCO 506, the band-pass filter 508, the splitter 510, the amplifier 512, the TX antenna 514, the Rx antenna 516, the low-noise pre-amplifier 518, the mixer 520, the low pass filter 522, the amplifier 524, the splitter 526, the ADC 528, and the distance signal 530.

In addition, the overview 700 further includes components the RIS detector module 534. For instance, the RIS detector module 534 includes a chirp frequency average block 702, a subtraction block 704 (e.g., an absolute subtraction (abs) of a first input (a) and a second input (b)), a threshold block 706, and a frequency comparator block 708. For example, the subtraction block 704 can obtain an output from the chirp frequency average block 702, which can perform a moving average calculation, and the IF signal from the splitter 526. Based on performing a subtraction and then using the frequency comparator block 708 to compare the output from the subtraction block 704 with the threshold 706, the RIS detection flag 536 can be determined. Based on the RIS detection flag 536, feedback 710 can be provided back for the Chirp modulation 502.

For example, to detect the presence of the RIS device (e.g., the RIS device 204 of FIG. 2), FIG. 7 shows the main functional components. For instance, the reflected signal (e.g., the RX signal from the RX antenna 516) can be processed by the radar device as usual and reaches the power amplifier 524 after the low pass filter 522. Here, the signal, which is at the IF stage due to the mixing operation performed by the mixer 520, is split using the splitter 526 into two branches. One goes to the standard output of the radar (e.g., the distance signal 530) and the other one is provided to the RIS detector module 534.

The RIS detector module 534 can perform a classification functionality and/or step. For instance, the simplest classification step can account for the comparison of the continuous distance readings over a moving average using the same time window as the total modulation period. The moving average is performed by the chirp frequency average module (e.g., the chirp frequency average block 702). In the case of an RIS device within an area, the instantaneous readings (e.g., the value corresponding to different chirp frequencies within the chirp band) can exhibit a variation in the measured distance for a specific portion of the band. If the reading distance differs from the average much more than the device resolution in a frequency window, the presence of the RIS device can be detected by comparing the deviation between the distance in this frequency band and the average one. This operation is performed by the subtracting module (e.g., the subtracting block 704) and the comparator module (e.g., the comparator block 708).

In other words, the RIS detector module 534 can operate based on collecting the values of the signal out of the splitter 526, which can be the IF signal. The rectangular pulse shown in the signal representation 604 is due to the RIS presence, as it virtually increases the range (e.g., SΔt increases). The average is performed over a time window and embodiments of the present disclosure can use it to have a reference to compare with the current value of the IF signal. If the difference between the current value of the IF and the average out of the chirp frequency average block 702 (e.g., the chirp frequency average module) is greater than a threshold 706, then a positive RIS detection is detected (e.g., the RIS detection flag 536 indicates detection of an RIS).

In some examples, sudden spikes in the distance can be detected even if no RIS is deployed (e.g., if there are no RIS devices within the environment). For example, other entities can interfere temporarily with the radar operation (e.g., the sudden passage of nomadic obstacles in front of the radar can result in a rapid change in the detected distance). However, such alterations would not always be located in the same frequency band. Thus, if the alteration of the signal is observed to change between cycles under otherwise similar conditions, the presence of an RIS device can be inferred. To do so, the output of the RIS detector module 534 can be processed over several iterations to ensure that the observed behavior is repeated in consecutive chirps for the same frequency bands. In other words, multiple chirps (e.g., chirp modulations 502) can be processed by the overview 700 over multiple iterations and the RIS detector module 534 can provide an output (e.g., RIS detection flags 536) for each iteration. Based on a comparison of the multiple outputs and determining that the multiple outputs across the iterations are located within the same frequency band, the presence of an RIS device within the environment can be determined.

Additionally, and/or alternatively, based on detection of an RIS, an optional feedback step 710 can be performed. When performed, the feedback step 710 can be used towards the chirp modulation phase. For instance, based on the hardware capabilities of the radar device, the chirp modulation 502 can be updated to move (e.g., temporality and/or statically) the operational bandwidth outside of the RIS band of influence to avoid its effect and improve reliability on readings. In some instances, reducing the chirp duration/slope can have a non-negligible effect on the spatial resolution of the radar device. In other words, in some examples, the feedback step 710 might not be performed based on hardware capabilities of the radar device. In other examples, the feedback step 710 can be performed. When performing the feedback step 710, in a subsequent iteration, the chirp modulation 502 can be updated such that the operational bandwidth (e.g., the bandwidth B shown in FIG. 3) is moved to be outside of the RIS band of influence, which assists in avoiding the effects of the RIS device and can improve reliability of readings of the radar device.

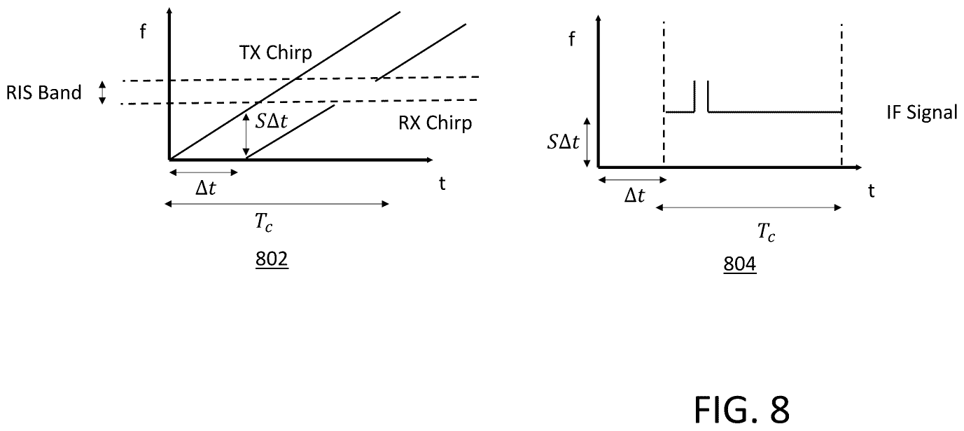

In another embodiment, the static RIS device reflecting the impinging signal away from the receiver is described. For instance, with reference to the generic FMCW operations and signal representations depicted in FIG. 4, FIG. 8 depicts the expected behavior of an FMCW radar signal when considering a static RIS device reflecting the impinging signal away from the receiver. For instance, FIG. 8 illustrates another set of resulting signal representations 802-804 in the presence of an RIS according to one or more embodiments of the present disclosure. For example, the signal representations 802-804 can be related to the resulting IF signals that are obtained in the presence of an RIS device with lost narrowband reflected signal and a static target.

In such a scenario, the RIS device can create a reflection that bounces the signal transmitted from the radar away from the radar (e.g., in a direction that does not reach any reflecting object), which can lead to an IF signal as depicted in FIG. 8. For example, recalling that only the portion of the chirp that belongs to the bandwidth of influence of the RIS is affected by the RIS presence, the reflection caused by the RIS device can create a void in a specific portion of the bandwidth on the received signal, which can be exploited for detection. In other words, as shown in the signal representation 802, the RX chirp for the RIS band (e.g., the frequency band that is impacted by the presence of the RIS device) is absent. Thus, now referring to the signal representation 804, instead of the earlier embodiment where a rectangular pulse is obtained due to the delay in receiving the reflected signal, the IF signal includes rising and falling edges that have a gap between them.

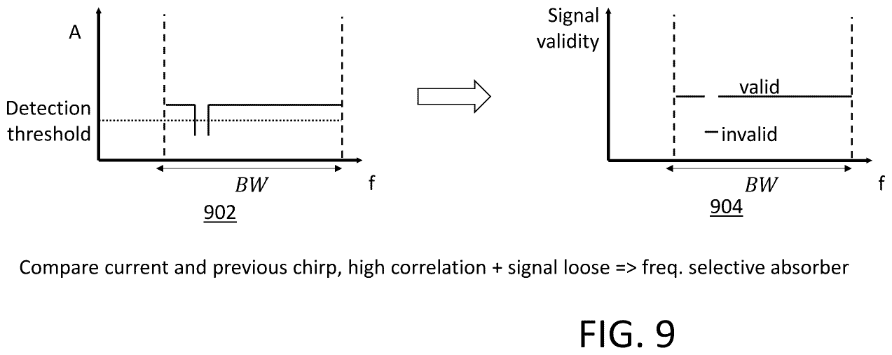

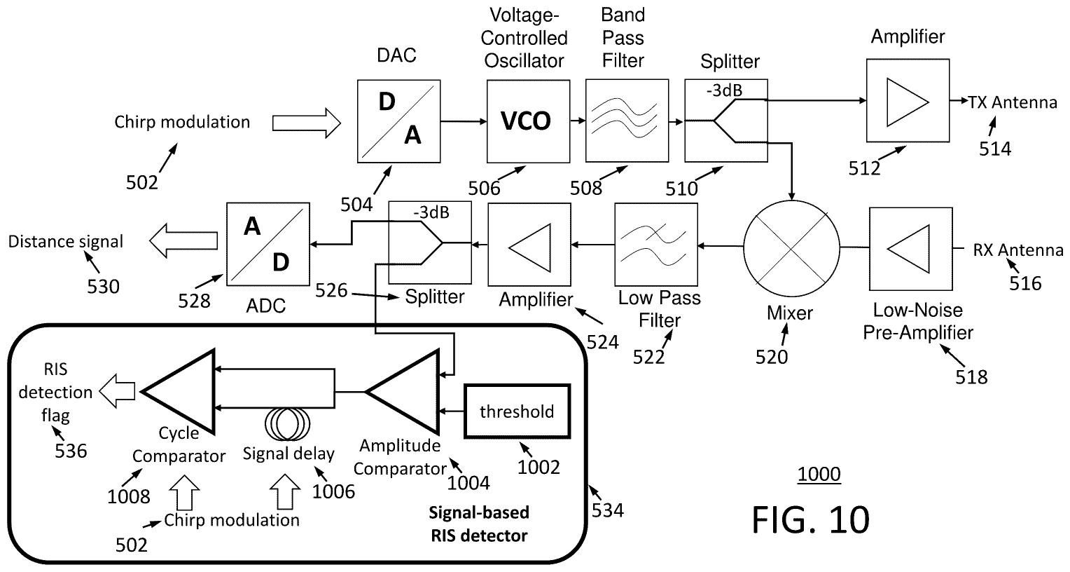

Turning to FIG. 9, FIG. 9 illustrates frequency dependent signal detection in the intermediate frequency according to one or more embodiments of the present disclosure. For example, as shown in graphical representations 902 and 904 of FIG. 9, the signal amplitudes of the IF signal are shown, with the gap representing the effect of the RIS device. For instance, recalling that due to the frequency dependence of the RIS device, the gap is limited to a given bandwidth, which can be leveraged to detect the RIS device. A postprocessing step can be applied to the radar distance readings over several modulation cycles (e.g., over several chirp modulations). If a single signal loss window arises, no RIS presence is inferred. However, if several signal loss windows are detected over the same frequencies, the presence of an RIS device and/or a frequency-selective absorber or reflector can be inferred. This will be described in further detail in FIG. 10.

In other words, FIG. 9 (e.g., the graphical representation 902) represents the amplitude A of the signal received at different chirp frequencies f within the chirp operational bandwidth (BW). In this case, the frequency on the abscissa is the received frequency and might not be the intermediate frequency. As such, FIGS. 8 and 9 can both indicate representations for the signal received when the RIS is reflecting towards an anechoic direction. Thus, they show where an obstacle is too far away from the robot 102, when there is no obstacle, or when there is an absorbing obstacle (e.g., an obstacle that absorbs the signal).

FIG. 10 illustrates yet another overview 1000 of a modification to the radar device to detect RIS devices based on signal detection according to one or more embodiments of the present disclosure. For instance, the overview 1000 includes many of the similar components and/or entities from the overview 500 such as the chirp modulation 502, the DAC 504, the VCO 506, the band-pass filter 508, the splitter 510, the amplifier 512, the TX antenna 514, the Rx antenna 516, the low-noise pre-amplifier 518, the mixer 520, the low pass filter 522, the amplifier 524, the splitter 526, the ADC 528, and the distance signal 530.

In addition, the overview 1000 further includes components the RIS detector module 534. For instance, the RIS detector module 534 includes the threshold block 1002, the amplitude comparator 1004, the signal delay 1006, the cycle comparator 1008, the chirp modulation 502, and the RIS detection flag 536. The overview 1000 can be used to exploit the behavior detailed in FIGS. 8 and 9. For instance, the RIS detector module 534 shown in overview 1000 can allow for detecting RIS devices whenever these RIS devices reflect signals into a void such that no reading is retrieved (e.g., obtained by the RX antenna 516). For instance, the obtained radar readings can be compared with background noise to produce a Boolean indicator of the presence of valid readings. If, across several modulation cycles, there is a consistent failure in the readings and this failure occurs repeatedly over the same frequency band, the presence of an RIS and/or a frequency-selective absorber or reflector can be inferred.

In other words, the processed IF signal from the splitter 526 can be provided to the amplitude comparator 1004. The amplitude comparator 1004 can compare the amplitude of the processed IF signal with a threshold 1002, which can be the background noise threshold. Based on the comparison, the amplitude comparator 1004 provides an output (e.g., a Boolean indicator) of the presence of valid readings. The signal delay 1006 can perform signal delay such that the cycle comparator 1008 compares the output of the amplitude comparator 1004 over several cycles (e.g., several iterations of performing the overview 1000). Based on the comparison, the RIS detector module 534 can output an RIS detection flag 536 indicating whether there is a presence of an RIS device and/or a frequency-selective absorber or reflector. For instance, if across several modulation cycles (e.g., over several chirp modulations 502) the cycle comparator 1008 determines that there is a consistent failure (e.g., that there is a void that is detected for the same frequency band based on the output from the amplitude comparator), then the cycle comparator 1008 can provide an output indicating the presence of the RIS device and/or the frequency-selective absorber or reflector.

To put it another way, the threshold 1002 can be for example, the background noise threshold, or set based on other considerations such as device sensitivity, etc. The output of the comparator 1004 is depicted in the graphical representation 904. The device shown in FIG. 10 can compare the signal loss over two consecutive chirp modulation cycles, using a signal delay of one chirp modulation period 1006. This can allow for comparing signal losses, as depicted in FIGS. 8 and 9, against the previous chirp cycle. If the signal is lost on the same frequency interval in two consecutive cycles, embodiments of the present disclosure can determine that there is an RIS such as the RIS 204 (or a frequency selective absorber).

In yet another embodiment, the speed-based RIS detection is described. For example, radar devices can often be used in automotive scenarios to detect moving objects such as other cars in their nearby surroundings. At the same time, there is an ongoing effort in defining methods that allow fast RIS reconfigurations that are able to follow in space the movement of a mobile end-device. Therefore, in the following, a scenario where the target object (e.g., a car) can be moving is considered.

In FMCW radars, the Doppler effect can be used to estimate the velocity of the target object. To assess the plausibility of sudden signal changes, embodiments of the present disclosure can exploit this dual output of FMCW radars, which can include both a distance reading obtained from the elapsed time between emission and reception of each frequency and an independent speed reading obtained through the doppler shift of identifiable points of the transmitted signal (e.g., the maximum and minimum frequencies employed). For example, embodiments of the present disclosure can obtain a speed value based on computing the first derivative of the distance readings and compare it with the doppler-originated speed measurement.

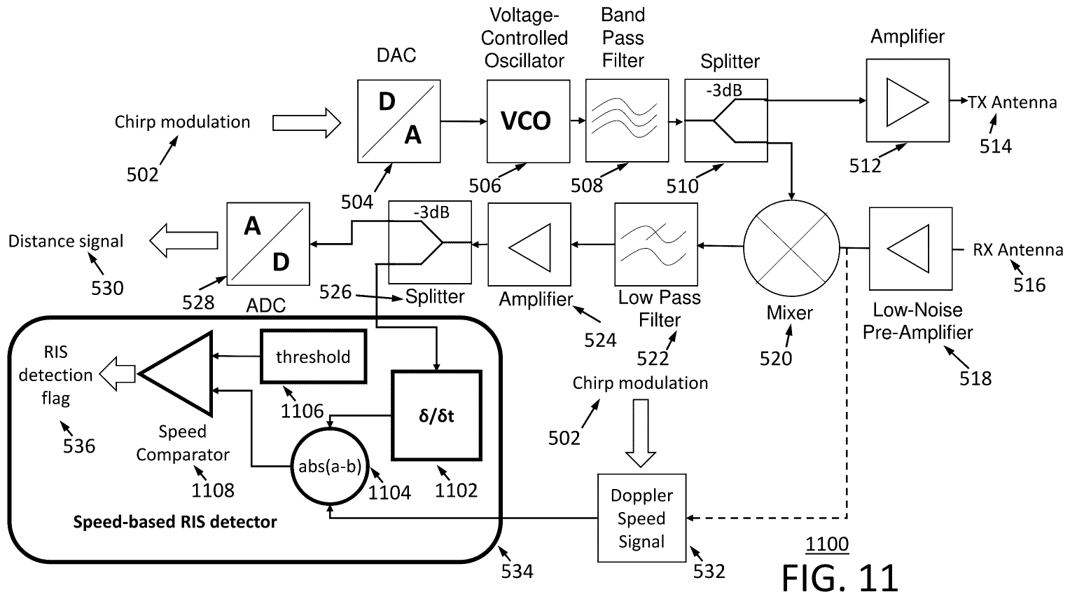

As an example, whenever the difference between these two is greater than the sum of their errors, or they are greater than the maximum acceleration considered plausible multiplied by the total modulation period, embodiments of the present disclosure can infer that a position change is beyond what can plausibly be considered a movement of the object. Such a change in position can indicate the presence of an RIS or a frequency-selective absorber or reflector. If the alteration of the signal is observed to change between cycles under otherwise similar conditions, the presence of an RIS can be inferred. This is described in FIG. 11.

For example, FIG. 11 illustrates yet another overview 1100 of a modification to the radar device to detect RIS devices based on speed readings according to one or more embodiments of the present disclosure. For instance, the overview 1100 includes many of the similar components and/or entities from the overview 500 such as the chirp modulation 502, the DAC 504, the VCO 506, the band-pass filter 508, the splitter 510, the amplifier 512, the TX antenna 514, the Rx antenna 516, the low-noise pre-amplifier 518, the mixer 520, the low pass filter 522, the amplifier 524, the splitter 526, the ADC 528, the distance signal 530, and the doppler speed signal block 532.

In addition, the overview 1100 further includes components the RIS detector module 534. For instance, the RIS detector module 534 includes the derivative block 1102 (8/8t block 1102), a subtraction block 1104 (e.g., an absolute subtraction (abs) of a first input (a) and a second input (b)), a threshold block 1106, a speed comparator 1108, and an RIS detection flag 536. For example, the processed IF signal can be provided from the splitter 526 to the derivative block 1102. The derivative block 1102 can process the processed IF signals (e.g., the distance readings) to generate a speed reading for the IF signal (e.g., perform a first derivative of the distance readings, which results in a speed reading). The speed reading for the IF signal is provided to the subtraction block 1104. Furthermore, the doppler speed signal block 532 can determine the doppler speed signal based on the RX signal (e.g., after the low-noise pre-amplifier 518 processes the RX signal from the RX antenna 516 but prior to the mixer 520 mixing the RX signal to obtain the IF signal) and the chirp modulation 502. The subtraction block 1104 can subtract the doppler speed signal from the doppler speed signal block 532 (e.g., a doppler-originated speed measurement) and the speed signal from the derivative block 1102 to obtain a subtraction output that is provided to the speed comparator 1108. The speed comparator 1108 can compare the subtraction output with a threshold 1106 (e.g., a threshold value), and based on the comparison, can output an RIS detection flag 536 indicating the presence of an RIS. For instance, when the difference between the doppler speed signal and the speed signal from the derivative block 1102 is greater than the sum of their errors and/or the difference is greater than the maximum acceleration considered plausible multiplied by the total modulation period, the speed comparator 1108 can indicate detection of the RIS device. In other words, the speed comparator 1108 can determine that such a change in position is beyond what could plausibly be considered movement of an object, and based on this determination, the speed comparator 1108 can determine an indicate indicating the presence of an RIS device and/or a frequency-selective absorber or reflector. Additionally, and/or alternatively, based on the alternation of the signal being observed to change between cycles under otherwise similar conditions, the presence of an RIS device can be inferred.

In other words, if the detected object is moving, due to doppler effect, the slope in frequency of the received signal is slightly different from the one in the transmitted signal. The doppler speed signal block 532 leverages this to estimate the object speed. Similarly, the intermediate frequency signal out of the splitter 526, in standard operational conditions (e.g., no RIS), exhibits a slope that depends on the doppler and is proportional to the speed of the target. This slope is computed with the derivative block 1102 (e.g., derivative module). An RIS (e.g., the RIS 204), due to the selective frequency behavior, can appear to move forward and back extremely fast on top of the speed estimated by the doppler speed signal block 532. These fast speed changes (within a chirp cycle) can be detected by the derivative block 1102 and, if compared (in subtraction block 1104) with the estimate output of the doppler speed signal block 532, which provides an average speed over the chirp, can be leveraged to detect the RIS.

In some instances, it may be highlighted that the detection process described above may depend upon a sensitivity threshold (e.g., indicated by the threshold block 1106). Such a threshold is use-case dependent and additional constraints can be considered to define such a value. This threshold indicated by the threshold block 1106 can be any threshold value and/or determination that can be used to detect the presence of an RIS device.

In some examples, in automotive scenarios, radars generally obtain readings from a single frontal direction. However, in other examples, the radar can obtain readings of the surroundings by changing the beam/antenna direction to reproduce the overall environment. In this context, embodiments of the present disclosure can apply the same principle by looking for a change in a particular region of the reproduced environment that is not consistent with the speed readings of that region reconstructed from the doppler shift of the received signals.

In yet another embodiment, a machine-learning characterization of available data is described. For example, in the above, embodiments of the present disclosure can extract information available at the physical level in key points of the radar architecture and then exploit the special behavior of the received signal when interacting with an RIS device. A particularly broad way of detecting these and more complex information patterns to materialize embodiments of the present disclosure can be to make use of other signal processing techniques at software level, after the extraction of data samples from the radar device. For instance, in some examples, this can optionally include and/or involve machine learning (ML) algorithms. For example, embodiments of the present disclosure can use a neural network classifier. Additionally, and/or alternatively, embodiments of the present disclosure can use other techniques that allow a machine learning based processing of the information taken as input by a machine learning based RIS detector module. For instance, the machine learning based RIS detector module can be trained to perform the signal processing tasks for revealing the presence of the RIS devices within the environment.

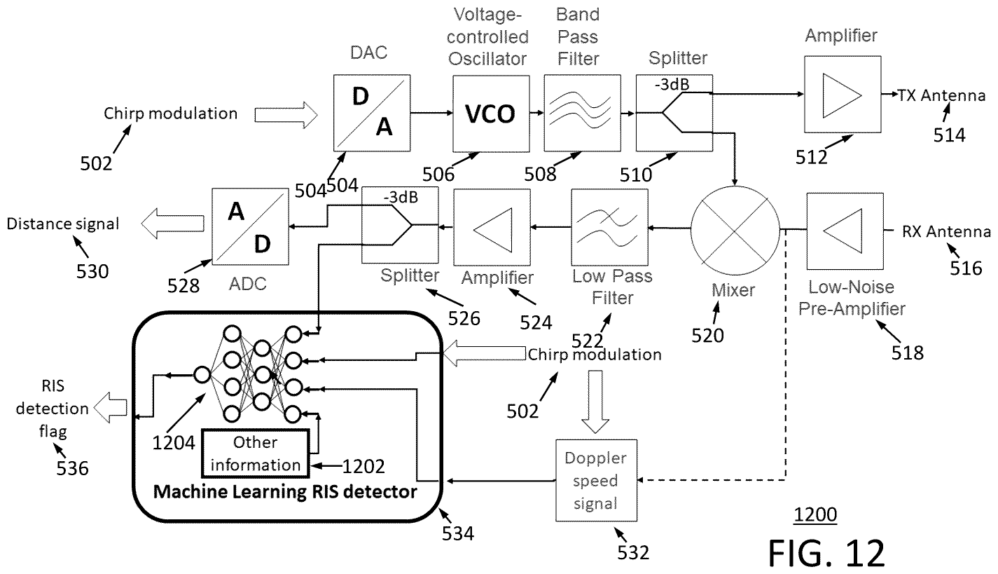

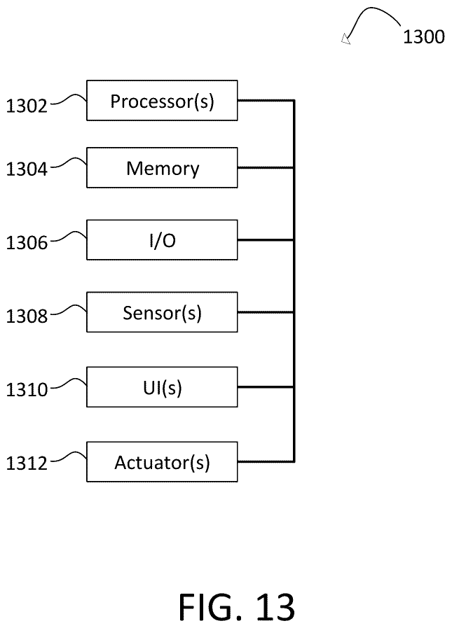

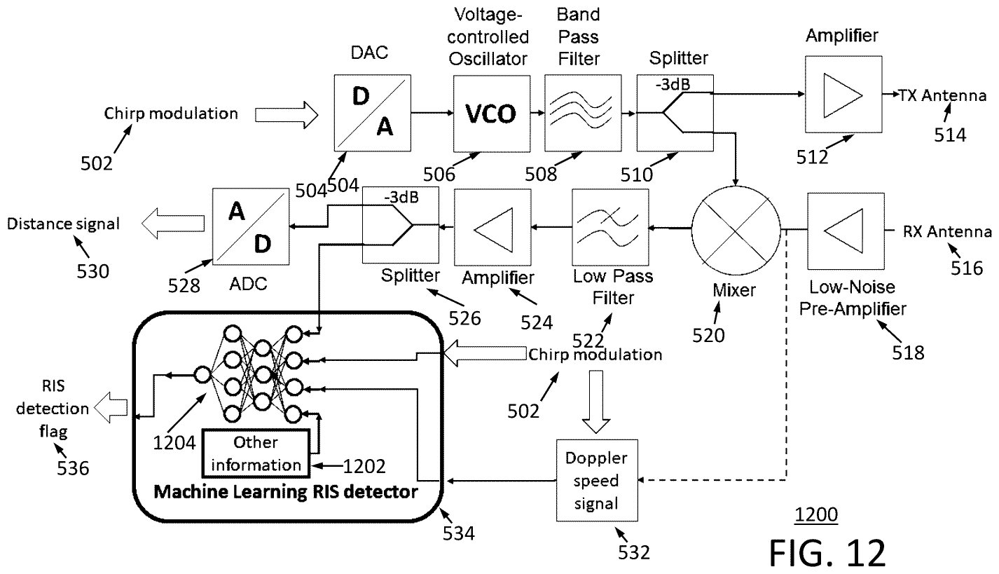

As described in the previous embodiments, the information taken in as input for this module can include, but is not limited, the doppler speed signal, the received signal after the splitter, the modulation chirp waveform, and/or other information. The entire set of the aforementioned information and/or a subset of it can be used as input features for the machine learning approach. Additional information can also be relevant depending on the application scenario (e.g., the position and orientation of the TX and RX antennas, if available, can be provided in the module to improve accuracy). For this embodiment, a suitable dataset of examples of input information can be generated, including a variety of situations with and without RIS devices in the line of sight of the radar. Then, a neural network, a reinforcement agent, and/or other data-driven architecture can be trained to identify those situations. While ML provides a suitable implementation option for the RIS detector module, the same set of input data can be used to design signal processing modules not leveraging ML (e.g., other estimators specifically configured for the RIS detection task based on processing the signal in input, such as Bayesian estimators, fast Fourier transform (FFT) based estimators, and so on). This embodiment is described in further detail in FIG. 12.

For example, FIG. 12 illustrates yet another overview 1200 of a modification to the radar device to detect RIS devices based on a data-driven architecture according to one or more embodiments of the present disclosure. For instance, the overview 1200 includes many of the similar components and/or entities from the overview 500 such as the chirp modulation 502, the DAC 504, the VCO 506, the band-pass filter 508, the splitter 510, the amplifier 512, the TX antenna 514, the Rx antenna 516, the low-noise pre-amplifier 518, the mixer 520, the low pass filter 522, the amplifier 524, the splitter 526, the ADC 528, the distance signal 530, and the doppler speed signal block 532.

In addition, the overview 1200 further includes components the RIS detector module 534. For instance, the RIS detector module 534 includes a data driven architecture 1204 and other (e.g., additional) information 1202. For example, the data driven architecture 1204 shown in FIG. 12 is an ML RIS detector that utilizes one or more ML and/or artificial intelligence (AI) algorithms and/or models. However, as mentioned above, in other examples, the data driven architecture can include other signal processing modules that do not leverage ML such as other estimators that are configured to the RISK detection task (e.g., Bayesian estimators and/or FFT based estimators).

As shown in FIG. 12, the data driven architecture 1204 can be an ML based architecture such as a neural network, reinforcement agent, and/or other types of ML and/or AI algorithms and/or models. The data driven architecture 1204 can be trained using training data, which can include the doppler speed signal from the doppler speed signal block 532, the chirp modulation 502, the processed IF signal from the splitter 526, and/or additional information. Additionally, and/or alternatively, the training data can further include other information 1202 such as the position and/or orientation of the TX and RX antennas 514 and 516 that are described above. Furthermore, the training data can include a variety of suitable datasets of examples of input information in a variety of situations with and without RIS devices in the line of sight of the radar device.

Subsequently, during inference, based on information from the overview 1200 such as the doppler speed signal from the doppler speed signal block 532, the chirp modulation 502, the processed IF signal from the splitter 526, the other information 1202 (e.g., the position and/or orientation of the TX and RX antennas 514 and 516), and/or additional information, the data driven architecture 1204 can process the input information to generate an output indicating the RIS detection flag 536 (e.g., an output indicating the presence of an RIS device).

In an embodiment, the present disclosure provides a method for detecting the presence of RIS devices with FMCW radars. For instance, the method can include a first step of processing the analog received signal after demodulation, filtration, and amplification steps to detect one of the expected behaviors (e.g., one or more characteristics) of a RIS under a FMCW radar signal. The method can include a second step of detecting different readings in the received signal amplitude only within a confined bandwidth. Possible signal variations include sudden signal loss or noticeable alteration of the amplitude within a confined bandwidth. The method can include a third optional step of taking the time derivative of the range signal to produce a speed signal to infer speed values out of the temporal variation of the distance readings, and comparing them with the speed readings obtained from doppler shift. The method can include a fourth step of comparing the difference in amplitude with respect to the average amplitude with a threshold. The method can include a fifth optional step of comparing the difference in the speed signal with a threshold. The method can include a sixth optional step of comparing the speed value of the previous step on current modulation cycle with the one of the previous one. The method can include a seventh step of, if the difference obtained in steps 4, 5, and/or 6, is above the threshold trigger, outputting a RIS detected signal. Otherwise, an RIS not detected signal can be output. The method can include an eighth step of repeating the previous steps and monitoring the outcome to confirm that the detection is repeated across several cycles in the same frequency window.

Embodiments of the present disclosure provide for the following improvements and technical advantages over existing technology including describing an RIS detector module 534 to be included in FMCW radar devices to enable the detection of RIS devices in the environment. The RIS detector module 534 can include the functionality of a signal-based detector that exploits frequency-selectivity properties of RIS devices that are impressed in the FMCW radar received signal to identify the presence of a RIS in a static and/or dynamic environment. Additionally, and/or alternatively, the RIS detector module 534 can include the functionality of a speed-based RIS detector that exploits the dual output of FMCW radars, e.g., distance reading derived from the elapsed time between subsequent chirp emissions, and speed reading obtained through the doppler shift effect, in conjunction with a sensitivity threshold, to enable RIS detection in presence of moving RISs (or moving Radar). Additionally, and/or alternatively, the RIS detector module 534 can include an optional software-based component (e.g., an ML RIS detector) to process the digital samples collected from the FMCW radar. The processing can involve using machine learning classification approaches or other classification algorithms.

In contrast to existing technology, embodiments of the present disclosure include the capability of detecting a RIS device deployed in the area. This may allow for avoiding both communication and sensing errors due to reflection properties of RIS devices in presence of uncoordinated and unaware electromagnetic wave propagation.

Referring to FIG. 13, a processing system 1300 can include one or more processors 1302, memory 1304, one or more input/output devices 1306, one or more sensors 1308, one or more user interfaces 1310, and one or more actuators 1312. Processing system 1300 can be representative of each computing system disclosed herein.

Processors 1302 can include one or more distinct processors, each having one or more cores. Each of the distinct processors can have the same or different structure. Processors 1302 can include one or more central processing units (CPUs), one or more graphics processing units (GPUs), circuitry (e.g., application specific integrated circuits (ASICs)), digital signal processors (DSPs), and the like. Processors 1302 can be mounted to a common substrate or to multiple different substrates.

Processors 1302 are configured to perform a certain function, method, or operation (e.g., are configured to provide for performance of a function, method, or operation) at least when one of the one or more of the distinct processors is capable of performing operations embodying the function, method, or operation. Processors 1302 can perform operations embodying the function, method, or operation by, for example, executing code (e.g., interpreting scripts) stored on memory 1304 and/or trafficking data through one or more ASICs. Processors 1302, and thus processing system 1300, can be configured to perform, automatically, any and all functions, methods, and operations disclosed herein. Therefore, processing system 1300 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1300 can be configured to perform task “X”. Processing system 1300 is configured to perform a function, method, or operation at least when processors 1302 are configured to do the same.

Memory 1304 can include volatile memory, non-volatile memory, and any other medium capable of storing data. Each of the volatile memory, non-volatile memory, and any other type of memory can include multiple different memory devices, located at multiple distinct locations and each having a different structure. Memory 1304 can include remotely hosted (e.g., cloud) storage.

Examples of memory 1304 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1304.

Input-output devices 1306 can include any component for trafficking data such as ports, antennas (i.e., transceivers), printed conductive paths, and the like. Input-output devices 1306 can enable wired communication via USB®, DisplayPort®, HDMI®, Ethernet, and the like. Input-output devices 1306 can enable electronic, optical, magnetic, and holographic, communication with suitable memory 1304. Input-output devices 1306 can enable wireless communication via WiFi®, Bluetooth®, cellular (e.g., LTE®, CDMA®, GSM®, WiMax®, NFC®), GPS, and the like. Input-output devices 1306 can include wired and/or wireless communication pathways.

Sensors 1308 can capture physical measurements of environment and report the same to processors 1302. User interface 1310 can include displays, physical buttons, speakers, microphones, keyboards, and the like. Actuators 1312 can enable processors 1302 to control mechanical forces.

Processing system 1300 can be distributed. For example, some components of processing system 1300 can reside in a remote hosted network service (e.g., a cloud computing environment) while other components of processing system 1300 can reside in a local computing system. Processing system 1300 can have a modular design where certain modules include a plurality of the features/functions shown in FIG. 13. For example, I/O modules can include volatile memory and one or more processors. As another example, individual processor modules can include read-only-memory and/or local caches.

In some examples, embodiments of the present disclosure can be implemented as a computer-implemented method, computer system (comprising one or more processors and one or more storage devices) configured to perform the computer-implemented method and/or as a computer program for performing the computer-implemented method. For example, the computer-implemented method may include one or more steps and/or operations discussed above.

In some instances, one or more embodiments of the present disclosure can relate to machine learning. In particular, the model and/or architecture mentioned above can be a machine learning model.

Machine learning is a branch of artificial intelligence that involves the development of algorithms and models that allow computers to learn and make predictions or decisions without being explicitly programmed. It focuses on creating systems that can improve their performance over time by learning from data.

Training a machine-learning model refers to the process of teaching the model to make accurate predictions or decisions. During training, the model is exposed to a large amount of data, which is used to adjust the model's internal parameters or weights. The model learns patterns, relationships, or rules from the training data, allowing it to generalize and make predictions on new, unseen data.

Training data is the set of examples or instances that is used to teach a machine-learning model. It is often labeled data, meaning that each example is associated with a known outcome or target value. The training data consists of both input features and the corresponding output or target variable. The model learns from this data by analyzing the patterns and relationships between the input features and the target variable. Training algorithms, such as supervised learning, semi-supervised learning, unsupervised learning or reinforcement learning may be used for training the machine-learning model.

Machine-learning models, such as the machine-learning model being trained in the present disclosure, are often implemented as Artificial Neural Networks (ANNs), and in particular Deep Neural Networks, Support Vector Machines, Decision Tree models, or Random Forest models.

Examples may involve or relate to computer programs, including program codes to execute one or more of the mentioned methods when the program is executed on a computer, processor, or other programmable hardware component. As a result, steps, operations, or processes from various methods described above can also be executed by computers, processors, or other programmable hardware components. Examples may additionally cover program storage devices, such as digital data storage media, which are machine-, processor-, or computer-readable and encode and/or contain machine-executable, processor-executable, or computer-executable programs and instructions. These devices may include or be digital storage devices, magnetic storage media like magnetic disks and tapes, hard disk drives, or optically readable digital data storage media, for instance. Other examples encompass computers, processors, control units, field programmable logic arrays (FPLAs), field programmable gate arrays (FPGAs), graphics processing units (GPUs), application-specific integrated circuits (ASICs), integrated circuits (ICs), or system-on-a-chip (SoC) systems that are programmed to carry out the steps of the aforementioned methods. In simpler terms, examples may involve computer programs and storage media comprising computer programs, as well as hardware components like processors and control units, which can be programmed to execute the methods described above.

When certain aspects are mentioned in relation to a device or system, they should also be considered as descriptions of the corresponding methods. For example, a block, component, or functional aspect of the device or system may correspond to a method step or feature of the related method. Therefore, aspects described regarding a method should also be understood as depicting a corresponding element, property, or functional feature of the corresponding device or system. In simpler terms, if something is described in relation to a device or system, it can also be applied to the corresponding method, and vice versa.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications can be made, by those of ordinary skill in the art, within the scope of the following claims, which can include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for detecting the presence of a reconfigurable intelligence surfaces (RIS) device using a radar device, comprising:
based on transmitting a transmitted (TX) signal using a transmitter antenna of the radar device, receiving an analog received (RX) signal using a receiver antenna of the radar device;
mixing the TX signal and the analog RX signal using a mixer of the radar device to generate an intermediate frequency (IF) signal;
processing the IF signal using an RIS detector to detect a characteristic of the IF signal that indicates a presence of the RIS device; and
outputting an RIS detected signal based on the characteristic indicating the presence of the RIS device.

2. The computer-implemented method of claim 1, wherein the radar device is a frequency modulated continuous waveform (FMCW) radar device, wherein the TX signal and the analog received RX signal are FMCW radar signals, and wherein processing the IF signal using the RIS detector comprises:
providing the RIS detector with the IF signal after performing demodulation, filtration, and amplification; and
detecting the characteristic based on the provided IF signal.

3. The computer-implemented method of claim 1, wherein detecting the characteristic of the IF signal comprises:
detecting the characteristic of the IF signal within a confined operating frequency bandwidth associated with the RIS device, wherein the characteristic is a signal variation indicating a sudden signal loss within the confined operating frequency bandwidth or alterations of an amplitude of the IF signal within the confined operating frequency bandwidth.

4. The computer-implemented method of claim 1, wherein detecting the characteristic of the IF signal comprises:
processing the IF signal using a chirp frequency moving average to obtain an average amplitude;
determining a difference between an amplitude of the IF signal and the average amplitude;
comparing the difference with a threshold to determine the characteristic of the IF signal; and
generating the RIS detected signal based on the characteristic.

5. The computer-implemented method of claim 4, wherein the characteristic indicates whether the IF signal comprises a rectangular pulse for a time interval associated with a confined operating frequency bandwidth of the RIS device, wherein generating the RIS detect signal is based on the IF signal comprising the rectangular pulse, and wherein the computer-implemented method further comprises:
generating an RIS not detected signal based on the IF signal not including the rectangular pulse.

6. The computer-implemented method of claim 4, further comprising:
monitoring one or more additional characteristics of one or more additional IF signals associated with subsequent modulation cycles to confirm that the characteristic and the one or more additional characteristics are within a same frequency window, and wherein generating the generated RIS detected signal is based on the confirmation.

7. The computer-implemented method of claim 6, wherein monitoring the one or more additional characteristics of the one or more additional IF signals comprises:
obtaining the one or more additional IF signals based on mixing additional TX signals and additional RX signals in the subsequent modulation cycles; and
determining that the one or more additional characteristics of the one or more second IF signal comprise one or more rectangular pulses that are at the same frequency window as a rectangular pulse associated with the characteristic.

8. The computer-implemented method of claim 1, wherein detecting the characteristic of the IF signal comprises:
comparing, using an amplitude comparator, the IF signal with a background noise threshold to obtain a first amplitude output;
comparing, using a signal delay and a cycle comparator, the first amplitude output with previous amplitude outputs from the amplitude comparator to obtain the characteristic, wherein the characteristic indicates a sudden signal loss at a confined operating frequency bandwidth associated with the RIS device; and
generating the RIS detected signal based on the characteristic.

9. The computer-implemented method of claim 1, wherein detecting the characteristic of the IF signal comprises:
performing a doppler shift on the analog RX signal to obtain a doppler shifted signal;
computing a time derivative of the IF signal to obtain a speed signal, wherein the speed signal infers speed values out of a temporal variation of distance readings associated with the IF signal; and
generating the RIS detected signal based on a comparison of the speed signal and the doppler shifted signal.

10. The computer-implemented method of claim 9, wherein generating the RIS detected signal based on the comparison of the speed signal and the doppler shifted signal comprises:
determining a difference between the speed signal and the doppler shifted signal; and
comparing the difference with a threshold to generate a speed comparator output, wherein generating the RIS detected signal is based on the speed comparator output.

11. The computer-implemented method of claim 10, wherein generating the RIS detected signal comprises:
comparing the speed comparator output with a previous speed comparator output that is associated with a previous modulation cycle; and
generating the RIS detected signal based on the comparison between the speed comparator output and the previous speed comparator output.

12. The computer-implemented method of claim 1, wherein the RIS detector is a machine learning (ML) RIS detector, and wherein processing the IF signal comprises:
processing the IF signal and additional information using an ML based architecture to detect the characteristic indicating the presence of the RIS device, wherein the additional information comprises a doppler speed signal, a chirp modulation, position information associated with the transmitter antenna and the receiver antenna, and/or orientation information associated with the transmitter antenna and the receiver antenna.

13. The computer-implemented method of claim 12, wherein the ML based architecture comprises a neural network or a reinforcement agent, and wherein the method further comprises:
obtaining training data comprising first input information associated with one or more first environments having one or more training RIS devices within the one or more first environments and second input information associated with one or more second environments without having the one or more training RIS devices within the one or more second environments; and
training the neural network based on training data.

14. A computer system for detecting the presence of a reconfigurable intelligence surfaces (RIS) device using a radar device, the computer system comprising one or more hardware processors, which, alone or in combination, are configured to provide for execution of the following steps:
based on transmitting a transmitted (TX) signal using a transmitter antenna of the radar device, receiving an analog received (RX) signal using a receiver antenna of the radar device;
mixing the TX signal and the analog RX signal using a mixer of the radar device to generate an intermediate frequency (IF) signal;
processing the IF signal using an RIS detector to detect a characteristic of the IF signal that indicates a presence of the RIS device; and
outputting an RIS detected signal based on the characteristic indicating the presence of the RIS device.

15. A tangible, non-transitory computer-readable medium having instructions thereon which, upon being executed by one or more processors, alone or in combination, provide for execution of a method for detecting the presence of a reconfigurable intelligence surfaces (RIS) device using a radar device comprising the following steps:
based on transmitting a transmitted (TX) signal using a transmitter antenna of the radar device, receiving an analog received (RX) signal using a receiver antenna of the radar device;
mixing the TX signal and the analog RX signal using a mixer of the radar device to generate an intermediate frequency (IF) signal;
processing the IF signal using an RIS detector to detect a characteristic of the IF signal that indicates a presence of the RIS device; and
outputting an RIS detected signal based on the characteristic indicating the presence of the RIS device.
